(19) United States
(12) Patent Application Publication
(10) Pub. No.: US 2013/0069976 A1
(43) Pub. Date: Mar. 21, 2013

(54) APPARATUS AND METHOD FOR GENERATING AN EFFECT ASSOCIATED WITH A KEYWORD

(71) Applicant: Na Ri LEE, Seoul (KR)

(72) Inventor: Na Ri LEE, Seoul (KR)

(73) Assignee: PANTECH CO., LTD., Seoul (KR)

(21) Appl. No.: 13/584,648

(22) Filed: Aug. 13, 2012

(30) Foreign Application Priority Data
Sep. 15, 2011 (KR) 10-2011-0092924

(51) Int. Cl. G09G 5/00

(52) U.S. Cl. 345/619

(57) ABSTRACT

An apparatus to generate an effect associated with a keyword, the keyword being selectable by a user, includes a display unit to view the content; a database to store a keyword and an effect; and a controller to allow a user of the terminal to set an association with the keyword, the effect, and the content, wherein the terminal executes the effect if the keyword matches the content in response to the content being viewed. a method for providing content on a terminal, includes: displaying the content; storing a keyword and an effect; associating the keyword with the effect; and executing the effect if the keyword is displayed among the content.

### CROSS-REFERENCE TO RELATED APPLICATION

This application claims priority from and the benefit under 35 U.S.C. §119(a) of Korean Patent Application No. 10-2011-0092924, filed on Sep. 15, 2011, which is hereby incorporated by reference for all purposes as if fully set forth herein.

### BACKGROUND

1. Field

Exemplary embodiments of the present invention relate to an apparatus and method for generating an effect associated with a keyword if the keyword appears while a user of a terminal is viewing content through various operations, such as scrolling.

2. Discussion of the Background

FIG. 1 is a flowchart illustrating a method for displaying a text-based list on a terminal according to the prior art.

A terminal may display content in various forms, such as a list, while being able to receive a user input. The terminal may determine whether a user's input is received as a touch or a drag in a standby mode. In response to the touch being received, the terminal may determine whether a touched location corresponds to a list area or location, and may output data associated with the list if the touched location corresponds to the list area.

In response to a drag being received, the computer may determine whether a drag direction corresponds to an up-to-down movement or a down-to-up movement, and may output a previous list or a subsequent list according to the drag direction.

If a user views text while scrolling up or scrolling down and additionally information is provided, the user may miss content in which the user is interested in due to rapid scrolling and thus, the text being missed.

Thus, a display unit may have a small size to allow for the terminal to be mobile. Accordingly, the amount of small content displayed may be too much, therefore making a user miss some content while scrolling through the content on the display unit. Further, if a keyword is highlighted, and extra information is displayed due to the highlighting, content which the user may want to view might be blocked due to the extra information being displayed.

### SUMMARY

Exemplary embodiments of the present invention provide an apparatus and method for generating an effect associated with a keyword if the keyword appears while a user of a terminal is viewing content through various operations, such as scrolling. Specifically, the keyword may be set by a user and various parameters associated with the effect may also be set by a user through a user-interface provided on a terminal.

Additional features of the invention will be set forth in the description which follows, and in part will be apparent from the description, or may be learned by practice of the invention.

An exemplary embodiment of the present invention discloses a terminal to provide content, including: a display unit to display the content; a database to store a keyword and an effect; and a controller to set an association with the keyword and the effect, wherein the terminal executes the effect if the keyword is displayed among the content.

An exemplary embodiment of the present invention discloses a method for providing content on a terminal, including: displaying the content; storing a keyword and an effect; associating the keyword with the effect; and executing the effect if the keyword is displayed among the content.

An exemplary embodiment of the present invention discloses a method for setting an effect associated with a keyword, including: providing a user-interface to set the effect associated with the keyword; receiving the user setting; and displaying the effect associated with the keyword based on the user setting, if the keyword is displayed among content.

It is to be understood that both the forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a flowchart illustrating a method for displaying a text-based list on a terminal according to the prior art.

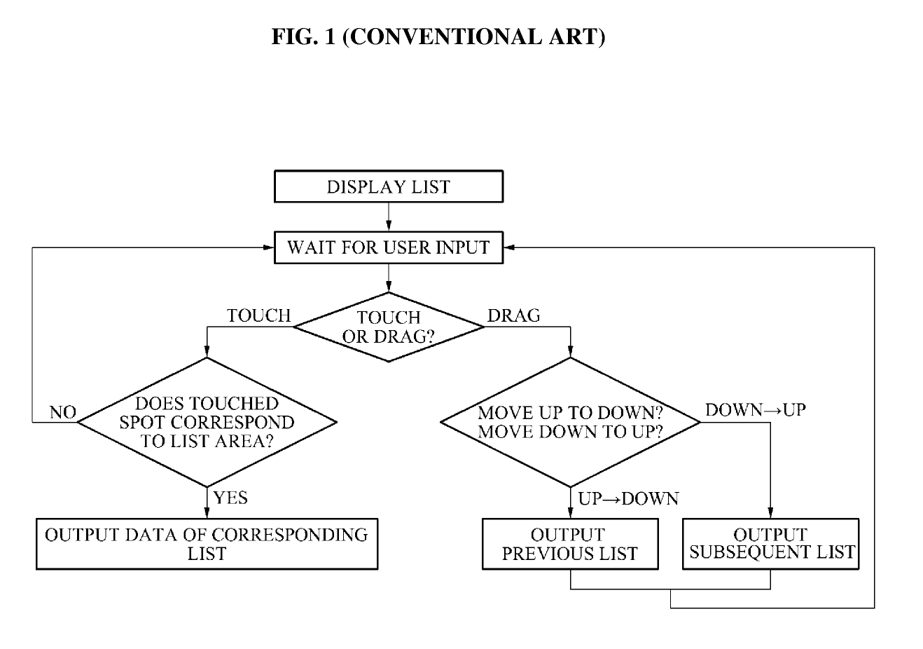

FIG. 2 is a block diagram illustrating an apparatus to display content according to an exemplary embodiment of the present invention.

FIG. 3 is a flowchart illustrating method for displaying content according to an exemplary embodiment of the present invention.

FIG. 4 is a diagram illustrating a user-interface to set various parameters according to an exemplary embodiment of the present invention.

FIG. 5 is an illustration of generating an effect based on a met condition associated with a keyword according to an exemplary embodiment of the present invention.

FIG. 6 is an illustration of a bulletin board according to an exemplary embodiment of the present invention.

FIG. 7 is an illustration of a portal site according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

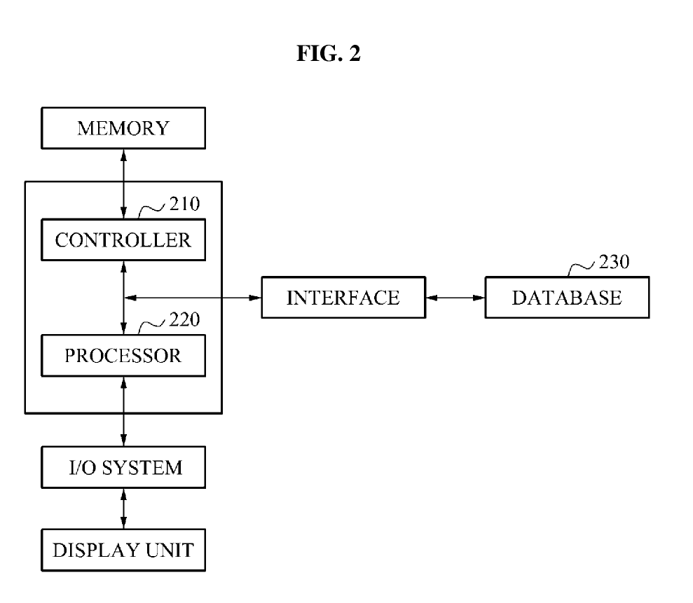

FIG. 2 is a block diagram illustrating an apparatus to display content according to an exemplary embodiment of the present invention.

Referring to FIG. 2, an apparatus to display a text-based list may include a controller 210, a processor 220, and a database 230.

The database 230 may store a keyword using a server (which may or may not be external). The keyword may be generated by a user input, a popular search word, a user or device location, an environment, a relationship with another user, or any combination of one or more of the above. The database 230 may store an effect associated with the keyword. For example, this effect may be stored on a server and be one or more of a sound, a vibration, a pop-up, a focus in and out, a fade in and out, and a screen flickering. The database 230 may detect that the keyword is at a specific location via the controller 210, and may provide an effect associated with the keyword in response to a request from the processor 220.

In response to content being displayed, the controller 210 may prepare for the generating of the effect by detecting the keyword at a specific location. For example, the controller 210 may continually monitor content being scrolled or displayed on a display unit, and correlate the various content (as words or images) with stored keywords in database 230. If the content matches the keyword, and if it is at a certain location on the display unit, the controller 210 may control the processor 220 to produce or generate an effect. In addition to the keyword being associated with a location on the display unit, the keyword may also be associated with one or more of the following effects: a sound, a vibration, a pop-up, a focus in and out, a fade in and out, and a screen flickering.

In generating an effect, the processor 220 may retrieve the specific effect from the database 230.

The controller 210 may display content (which may be text based) by allowing a user to scroll in an upward or downward direction via a scrolling operation. The controller 210 may detect a text that matches a stored keyword and is displayed at a specific location on the display unit.

The processor 220 may generate an effect associated with the keyword in response to a detection of the keyword by the controller 210. The effect may be set, and be one or more of the following a sound, a vibration, a pop-up, a focus in and out, a fade in and out, and a screen flickering. A user may select which effect is correlated with a specific keyword or a category of keywords.

The processor 220 may provide a processed multimedia message in order to provide the effect. The multimedia message may be generated by combining multimedia information associated with the keyword.

The processor 220 may adjust a magnitude of the effect in proportion to an interest corresponding to the keyword. The processor 220 may determine a level of interest set for the keyword, and may generate the effect by adjusting a magnitude of the effect according to the determined level of interest. For example, the magnitude may refer to the brightness or size of highlighting, the sound of audio, the speed of flickering, and the like.

For example, the controller 210 may detect that content is unread (which may include content that is not accessed or is read through quickly), and the processor 220 may generate an effect associated with the unread item in response to the controller 210 detecting that the content is unread. Thus, the magnitude of the effect may be reduced, as the content is unread and therefore, may be of little or no interest to a user. Conversely, the controller 210 may detect that a certain term or aspect of the content is of interest to a user, for example, by detecting that the content is selected or that the display unit maintains a view of the specific content for at least a threshold period of time. Thus, in this situation, a processor 220 may adjust the magnitude of how the effect is presented to be relatively high based on this detection.

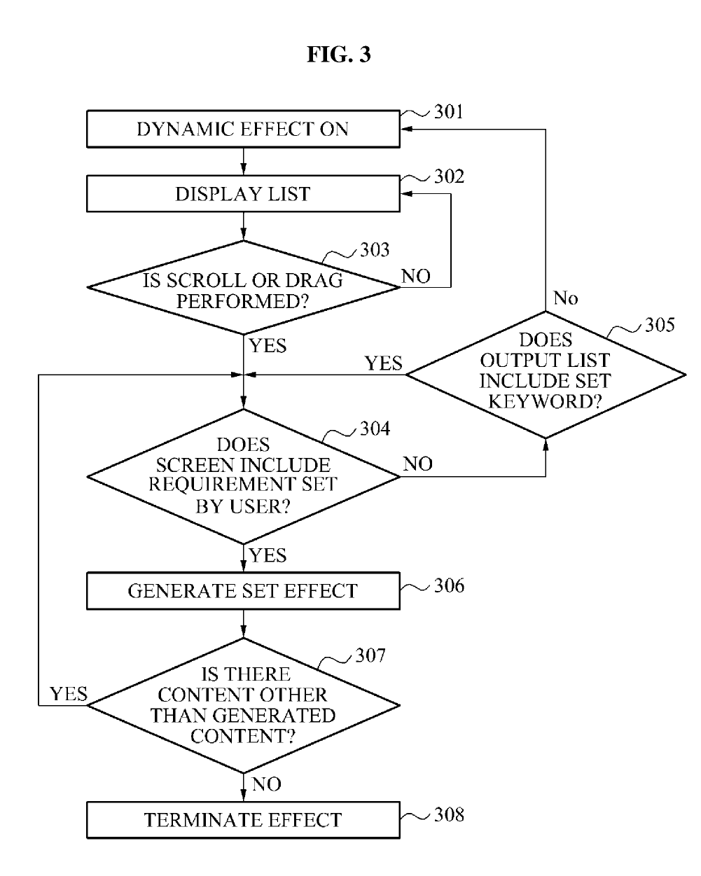

FIG. 3 is a flowchart illustrating method for displaying content according to an exemplary embodiment of the present invention. The method of FIG. 3 may be performed by the apparatus of FIG. 2, but is not limited as such.

In operation 301, a terminal may set and store, in a database, an effect corresponding to a keyword, and set whether this effect occurs. The terminal may prepare for initiating an effect by preparing various types of effects according to an attribute of the keyword.

In operation 302, the terminal may download or retrieve content, which may be text-based, to be displayed as a list. The source of the content may be from an internal source of the terminal, or externally retrieved, such as, through a web site or server. The terminal may download or retrieve the content and may display the downloaded or retrieved content according to an alignment reference. An alignment reference may refer to a markup language that indicates how the content is displayed.

The terminal may allow a user to scroll through the content (for example, by allowing the user to touch or drag a finger or stylus on the display unit) in operation 303, and may determine whether a keyword matching a text is displayed at a specific location on a display unit in operation 304 and 305. Specifically, in operation 304, a determination is made if the display unit has reached a specific condition in which an effect is triggered, i.e. through a set keyword and condition being reached. If yes, the terminal may proceed to operation 306. If no, in operation 305, a determination is made as to whether any keywords are set. If No, the terminal may return to operation 301. If yes, the terminal may return back to operation 304. In this case, a terminal may wait for a condition to be met to produce and generate an effect.

In operation 306, the terminal may generate the corresponding effect in response to the conditions of operation 305 being met. As stated above, the terminal may generate an effect according to a keyword and an associated condition.

In operation 307, the terminal may determine whether content other than the generated content is present. If yes, the terminal may return to operation 304. If no, the terminal may proceed to operation 308.

In operation 308, the terminal may terminate the effect if other content is absent. After terminating the effect, the terminal may delete the effect and the keyword from a memory, and may wait for a subsequent content display request.

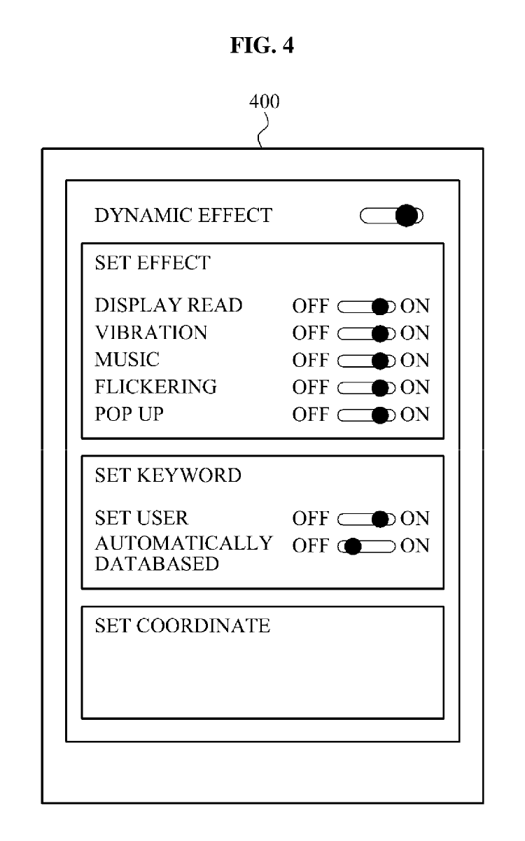

FIG. 4 is a diagram illustrating a user-interface to set various parameters according to an exemplary embodiment of the present invention.

Referring to FIG. 4, an implementation of a graphical user interface is shown. A display unit 400 may include toggle switches to turn off and on various settings and conditions. These various settings and conditions may include “set effect”, “set keyword”, and “set coordinate”. The “set effect” may include “display read”, “vibration”, “music”, “flickering”, and “pop up”, the “set keyword” may include “set user” and “automatically stored in a database”, and the “set coordinate” may include a specific location on a display unit. Thus, the toggle switches allow a user to set whether the effect occurs, how the effect is presented, if it is set by a user and stored in a database, and the location of the keyword that triggers the effect.

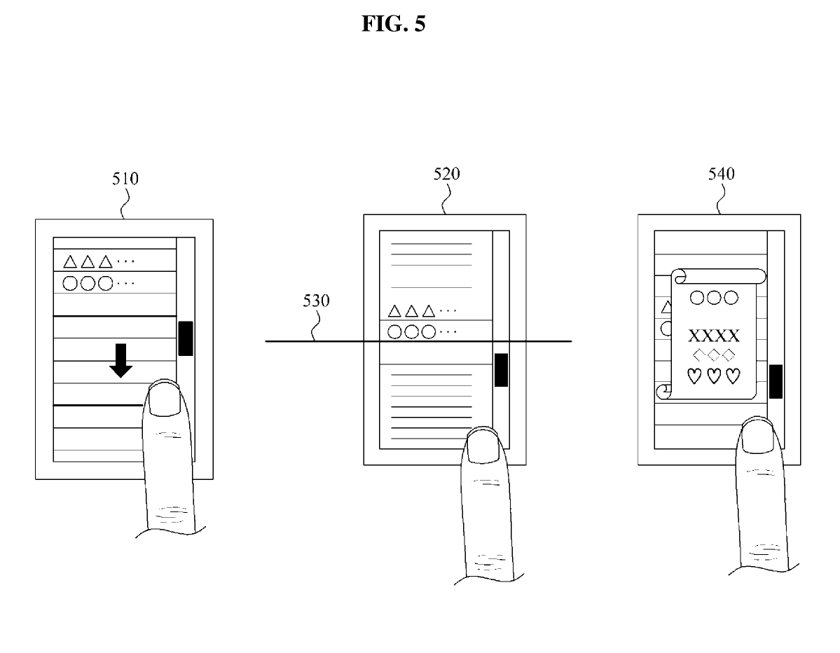

FIG. 5 is an illustration of generating an effect based on a met condition associated with a keyword according to an exemplary embodiment of the present invention.

In operation 510, a terminal may output content on a display unit, and may allow a user to scroll down via a scrolling operation.

In operation 520, the terminal may recognize that a keyword a user is interested in is displayed at a specific location 530 on a display unit, while the content is being scrolled through.

In operation 540, the terminal may initiate a pop-up event (or effect) corresponding to a keyword a user is interested in or has been set, in response to detecting the keyword at a specific location.

### Setting A Keyword

The terminal may set a keyword, by associating the keyword with an effect. As stated above, the keyword, the effect, and the association of the keyword and the effect may be stored in a database. The keyword may be inputted by a user or ascertained via a database or another source. The terminal may associate the keyword with a condition, such as a specific time or location. The computer may set, to the keyword, a popular search word or a frequently used word by accessing a server of a portal site.

### Setting Whether An Effect Occurs

As shown in FIG. 4, a user may be allowed to set whether an effect occurs. In addition to setting whether an effect occurs, a user may also set a specific location or time associated with a keyword or the producing and generating of the effect. For example, a user of a terminal may set a location at which an effect is initiated, and may initiate the effect in response to a keyword reaching the location. The terminal may initiate the corresponding effect by setting a keyword that is detected from the content being displayed at a specific time and location.

TABLE 1

| Classification | Factor | Specific level | Keyword example | Effect example |
|---|---|---|---|---|
| user | user | transportation, | Gyeongbok | sound, pop up, |
| | location | cultural space, | palace, bus | and the like |
| | | and tourist spot | line, and the | |
| | | | like | |
| environment | time | season, month, | birthday | sound, vibration, |
| | | and particular | present, | and the like |
| | | point in time | fashion for | |
| | | (anniversary day) | each weather, | |
| | | | and the like | |
| | weather | temperature, | weather | |
| | | amount of | forecast, and | |
| | | cloudiness, and | the like | |
| | | humidity | | |
| other users | distance | 1 m/5 m/10 m/ | profile of | screen |
| | from | 100 m, and the | another user, | flickering, fade |
| | another user | like | schedule, and | in/out, and the |
| | profile of | name, age, | the like | like |
| | another user | company, | | |
| | | academic ability, | | |
| | | and the like | | |
| | schedule of | word schedule, | | |
| | another user | anniversary day, | | |
| | | conference, and | | |
| | | the like | | |

Table 1 represents examples for correlating and associating keywords with various parameters for generating an effect. In setting a keyword, a user, an environment, and other users may be considered as relevant factors, and a factor and a specific level may be set for the corresponding keyword. For example, a sound, a pop up, a vibration, a flickering, and a fade in and out may be set as an effect.

### Setting A Specific Event

If a set keyword and a set associated condition are detected, the terminal may refer to the database and generate and produce the associated effect. The effect type may include a sound, a pop up, a vibration, a flickering, a fade in/out, and a focus in/out. The terminal may set the sound, the vibration, and the pop up as an effect based on the size and capabilities of the mobile terminal. As stated above the effect may be produced according to a level of association.

### Setting A Display Unit To Be Readable

In response to a display read being selected in a setting environment, the terminal may initiate an effect, and may enable the display unit to be available to a user through a touch input. The terminal may produce the effect to prompt a display unit to be read for a limited amount of time. The terminal may periodically delete or hide content corresponding to the display unit to be read, or may restore and display the content according to a request from a user. Thus, accordingly, additional content associated with an effect is selectively viewed and may not block other content being viewed while a user is scrolling through the content.

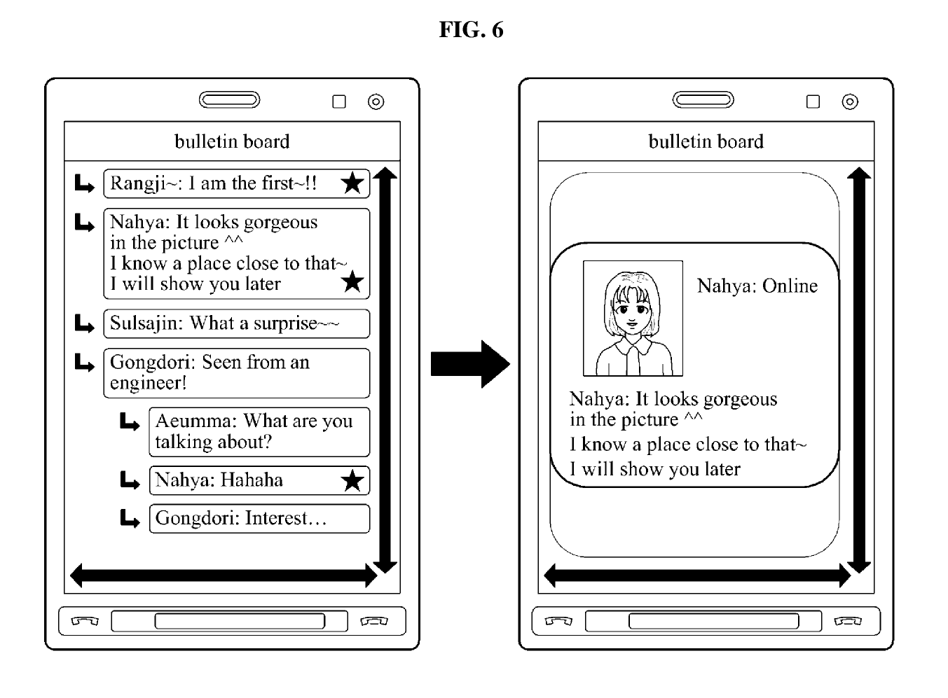

FIG. 6 is an illustration of a bulletin board according to an exemplary embodiment of the present invention.

A terminal may display a bulletin board, which shows content dynamically added by multiple users who have access to read and write on the bulletin board. The terminal may allow a keyword associated with an effect to be set if an action or text on the bulletin board corresponds to a specific user, a location on the display unit, or a time. The effect may be a pop-up message that has multimedia information associated with either the keyword or the user.

The terminal may display a received text message as a list, and may initiate and display an effect in response to a keyword, such as a character string of the text message being displayed at a specific location. The terminal may generate and produce the effect while at least two users are chatting or sharing text messages, thereby allowing a user to view the effect dynamically.

The terminal may also set the keyword, as described above, to be associated with a message from a mail message or a note text. The keyword may be ascertained and compared with a sender of mail message or any other property associated with messaging.

The computer may set, to a keyword, a name or a phone number, and may initiate the corresponding effect when a call list and a call log are retrieved. The computer may browse through a call list of main people in response to the corresponding effect being initiated.

### Media Files

The terminal may associate a keyword as a word in a file name included in a file list, and may generate and produce an effect if the keyword is detected while viewing or accessing a file list. Further, the terminal may prevent a user from viewing a certain file by generating and producing an effect corresponding to files that include the keyword in their file name.

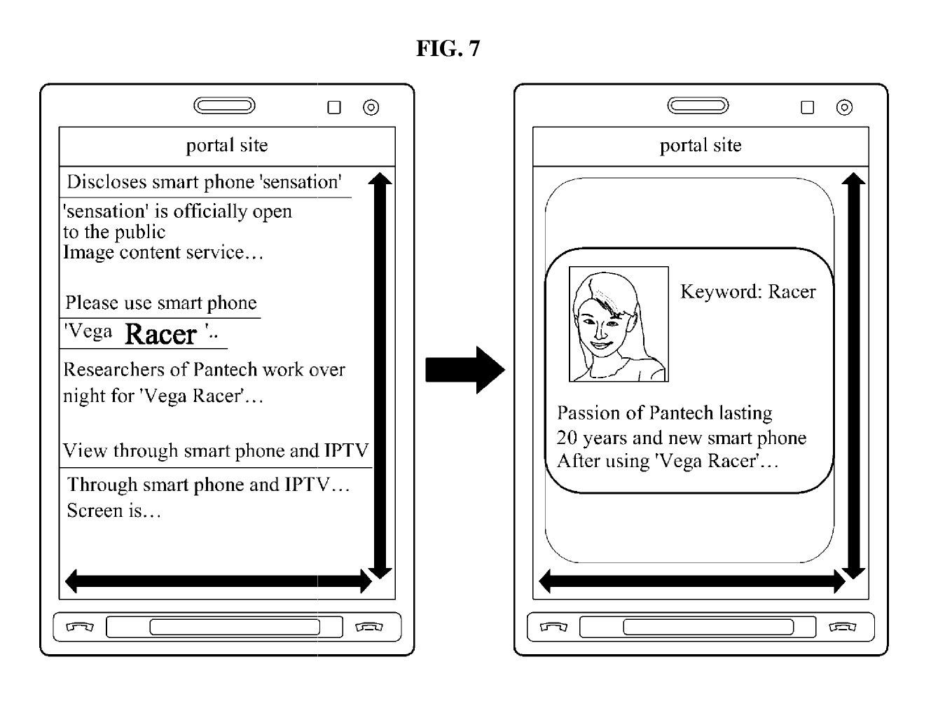

FIG. 7 is an illustration of a portal site according to an exemplary embodiment of the present invention.

A terminal may associate a keyword as a title of a news article retrieved by a portal site, and may generate and produce an effect if the terminal detects that the keyword appears if a user is viewing a list of news articles, or prompt a portal site for a list of news articles that contains the keyword. The terminal may highlight the keyword if it appears in the title with a specific effect (such as applying a bold effect on the found keyword), and may generate and produce an effect with a pop up window in response to the detected keyword satisfying an associated condition (such as location, time, etc . . . ).

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the well-known variety and available to those having skill in the computer software arts. Examples of non-transitory computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal to provide content, comprising:
a display unit to display the content;
a database to store a keyword and an effect; and
a controller to set an association with the keyword and the effect,
wherein the terminal executes the effect if the keyword is displayed among the content.

2. The terminal according to claim 1, wherein the effect is at least one of: a sound, a vibration, a pop-up, a focus in and out, a fade in and out, and a screen flickering.

3. The terminal according to claim 1, wherein the controller allows the user to set a level associated with the keyword, and
a magnitude of execution of the effect is based on the level associated with the keyword.

4. The terminal according to claim 1, wherein the display unit is a touch screen, and
the content is scrollable.

5. The terminal according to claim 1, wherein the controller allows the user to associate a location on the display unit with the keyword, and
the terminal executes the effect if the keyword is displayed at the location among the content.

6. The terminal according to claim 1, further comprising a toggle switch to switch a source of the keyword, wherein a first state of the toggle switch indicates that the keyword is sourced from the user, and a second state of the toggle switch indicates that the keyword is generated from an operation of the terminal.

7. The terminal according to claim 6, wherein the operation comprises the user touching a portion of the content a specific number of times.

8. The terminal according to claim 6, wherein the operation comprises the user viewing a portion of the content for a threshold duration.

9. The terminal according to claim 1, wherein the content is information retrieved from a portal server.

10. A method for providing content on a terminal, comprising:
displaying the content;
storing a keyword and an effect;
associating the keyword with the effect; and
executing the effect if the keyword is displayed among the content.

11. The method according to claim 10, wherein the effect is at least one of: a sound, a vibration, a pop-up, a focus in and out, a fade in and out, and a screen flickering.

12. The method according to claim 10, further comprising setting a level associated with the keyword, and
executing the effect at a magnitude based on the level associated with the keyword.

13. The method according to claim 10, wherein the terminal performs the displaying on a scrollable touch screen.

14. The method according to claim 13, further comprising associating a location on the scrollable touch screen with the keyword, and
executing the effect if the keyword is displayed among the content at the location.

15. The method according to claim 10, wherein the keyword is sourced from the user, or is generated from an operation of the terminal.

16. The method according to claim 15, wherein the operation comprises the user touching a portion of the content a specific number of times.

17. The method according to claim 16, wherein the operation comprises the user viewing a portion of the content for a threshold duration.

18. The method according to claim 10, further comprising retrieving the content from a portal server.

19. A method for setting an effect associated with a keyword, comprising:
providing a user-interface to set the effect associated with the keyword;
receiving the user setting; and
displaying the effect associated with the keyword based on the user setting, if the keyword is displayed among content.

20. The method according to claim 19, wherein the user-interface comprises a setting option comprising one or more of: the effect, the keyword, and a location of the keyword.
